(19) United States
(12) Patent Application Publication
(10) Pub. No.: US 2011/0234535 A1
(43) Pub. Date: Sep. 29, 2011

(54) TOUCHED POSITION IDENTIFICATION METHOD

(75) Inventors: Yi-Ling Hung, Taoyuan County (TW); Heng-Chang Lin, Taoyuan County (TW)

(73) Assignee: CHUNGHWA PICTURE TUBES, LTD., Taoyuan (TW)

(21) Appl. No.: 12/779,927

(22) Filed: May 13, 2010

(30) Foreign Application Priority Data
Mar. 25, 2010 (TW) 99108931

(51) Int. Cl. G06F 3/042

(52) U.S. Cl. 345/175

(57) ABSTRACT

A touched position identification method for identifying a position touched by an object on an optical touch panel is provided. The optical touch panel includes optical sensors, a light guide plate and a controllable light source. The controllable light source is disposed at a light incident side of the light guide plate. In the method, a turn-on action and a turn-off action are alternatively performed on the controllable light source with a predetermined interval. At least an n^{th} and a (n+2)^{th} image data corresponding to the turn-on action and a (n+1)^{th} and a (n+3)^{th} image data corresponding to the turn-off action is obtained through the optical sensors, wherein n is a natural number. An operation is performed on the image data to obtain a first comparative data and a second comparative data, and the position touched by the object is identified according to the first and the second comparative data.

### CROSS-REFERENCE TO RELATED APPLICATION

This application claims the priority benefit of Taiwan application serial no. 99108931, filed on Mar. 25, 2010. The entirety of the above-mentioned patent application is hereby incorporated by reference herein and made a part of specification.

### BACKGROUND OF THE INVENTION

1. Field of the Invention

The present invention generally relates to a touched position identification method, and more particularly, to a touched position identification method of an optical touch panel.

2. Description of Related Art

Along with the advancement and widespread of information technology, wireless mobile communication, and information appliances, the conventional input devices (such as keyboards and mice) of many information products have been gradually replaced by touch panels in order to achieve a more intuitional operation environment.

Existing touch panels can be categorized into resistive touch panels, capacitive touch panels, acoustic wave touch panels, optical touch panels, and electromagnetic touch panels, etc.

FIG. 1A and FIG. 1B are diagrams of a conventional optical touch panel respectively in a light-shading sensing mode and a light-reflecting sensing mode. Referring to FIG. 1A first, the optical touch panel 100 is disposed above a backlight module 102. The optical touch panel 100 has a plurality of optical sensors 104A, 104B, and 104C. When a user touches the optical touch panel 100 with a finger 106 or other objects, these optical sensors 104A, 104B, and 104C detect ambient light variations and output corresponding signals, so as to execute different predetermined functions.

To be specific, the optical sensors 104A, 104B, and 104C work in two different optical sensing modes. One is the light-shading sensing mode, and the other one is the light-reflecting sensing mode. Referring to FIG. 1A, in the light-shading sensing mode, the ambient light L_{E} is blocked at the position touched by the finger 106 therefore cannot enter the optical sensor 104B, but the ambient light L_{E} can enter the optical sensors 104A and 104C. Namely, the optical sensor 104B and the optical sensors 104A and 104C respectively detect an ambient light L_{E} of different intensity and accordingly output different signals, so that a touch sensing purpose is achieved.

Since the touch sensing purpose is achieved by detecting how the ambient light L_{E} is blocked in the light-shading sensing mode, the light-shading sensing mode fails when the intensity of the ambient light L_{E} is low. In addition, the touched point cannot be precisely determined because the finger 106 blocks some surface area.

Additionally, referring to FIG. 1B, in the light-reflecting sensing mode, when the finger 106 touches the optical touch panel 100, it reflects a backlight L_{B} emitted by the backlight module 102 back into the optical touch panel 100. In this case, the optical sensor 104B receives the reflected backlight L_{B} while the optical sensors 104A and 104C don't. Namely, the optical sensor 104B and the optical sensors 104A and 104C respectively detect a backlight L_{B} of different intensity and accordingly output different signals, so that a touch sensing purpose is achieved.

However, when the intensity of the ambient light L_{E} is too high, all the optical sensors 104A, 104B, and 104C receive very intensive ambient light L_{E}. In this case, the optical sensors 104A, 104B, and 104C cannot precisely identify the reflected backlight L_{B} and the ambient light L_{E}. Namely, the light-reflecting sensing mode fails. Additionally, when the optical touch panel 100 presents an image of low brightness (i.e., the backlight L_{B} is weak), the optical sensors 104A, 104B, and 104C cannot detect the reflected backlight L_{B}. Namely, the light-reflecting sensing mode also fails.

Generally speaking, the operation of an existing optical touch panel 100 relies greatly on the condition of the external light (the ambient light L_{E} and the backlight L_{B}). Thus, the optical touch panel 100 cannot be applied in different environments. In addition, a touched position has to be determined through a very complicated algorithm based on the detection result obtained in either the light-shading sensing mode or the light-reflecting sensing mode. Thus, the touched position may be incorrectly determined.

### SUMMARY OF THE INVENTION

Accordingly, the present invention is directed to a touched position identification method, wherein a light guide plate and a controllable light source are disposed such that an optical touch panel can be applied in environments having different light intensities.

The present invention provides a touched position identification method for identifying a position touched by an object on an optical touch panel. The optical touch panel includes a first substrate, a second substrate, a display medium between the first substrate and the second substrate, a light guide plate, and a controllable light source. A plurality of optical sensors is disposed on the first substrate. The light guide plate is disposed at one side of the second substrate. The controllable light source is disposed at a light incident side of the light guide plate. The touched position identification method includes following steps. A turn-on action and a turn-off action are alternatively performed on the controllable light source with a predetermined interval. At least a n^{th} image data and a (n+2)^{th} image data corresponding to the turn-on action and a (n+1)^{th} image data and a (n+3)^{th} image data corresponding to the turn-off action is obtained through the optical sensors, wherein n is a natural number. An operation is performed on the n^{th} image data and the (n+2)^{th} image data corresponding to the turn-on action and the (n+1)^{th} image data and the (n+3)^{th} image data corresponding to the turn-off action to obtain a first comparative data and a second comparative data, and the position touched by the object is identified according to the first comparative data and the second comparative data.

According to an embodiment of the present invention, in the touched position identification method, the first comparative data is obtained according to the n^{th} image data and the (n+1)^{th} image data, and the second comparative data is obtained according to the (n+2)^{th} image data and the (n+3)^{th} image data.

According to an embodiment of the present invention, in the touched position identification method, the first comparative data is obtained according to the n^{th} image data and the (n+1)^{th} image data, and the second comparative data is obtained according to the (n+1)^{th} image data and the (n+2)^{th} image data.

According to an embodiment of the present invention, the operation includes an addition operation.

According to an embodiment of the present invention, the operation includes a subtraction operation.

According to an embodiment of the present invention, the operation includes an XOR operation.

According to an embodiment of the present invention, the operation includes a difference operation.

According to the present invention, a light guide plate and a controllable light source are additionally disposed in an optical touch panel, and the light emitted by the controllable light source is controlled to be totally internally reflected in the light guide plate. Once an object touches the optical touch panel, the total internal reflection at the touched position is interrupted, so that the light transmitted within the light guide plate is emitted out of the light guide plate and towards the optical sensors. In particular, image data under different conditions is obtained by alternatively performing a turn-on action and a turn-off action on the controllable light source. An operation is then performed on the image data, so as to filter out noises caused by the ambient light and allow the touched position to be precisely determined.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are diagrams of a conventional optical touch panel respectively in a light-shading sensing mode and a light-reflecting sensing mode.

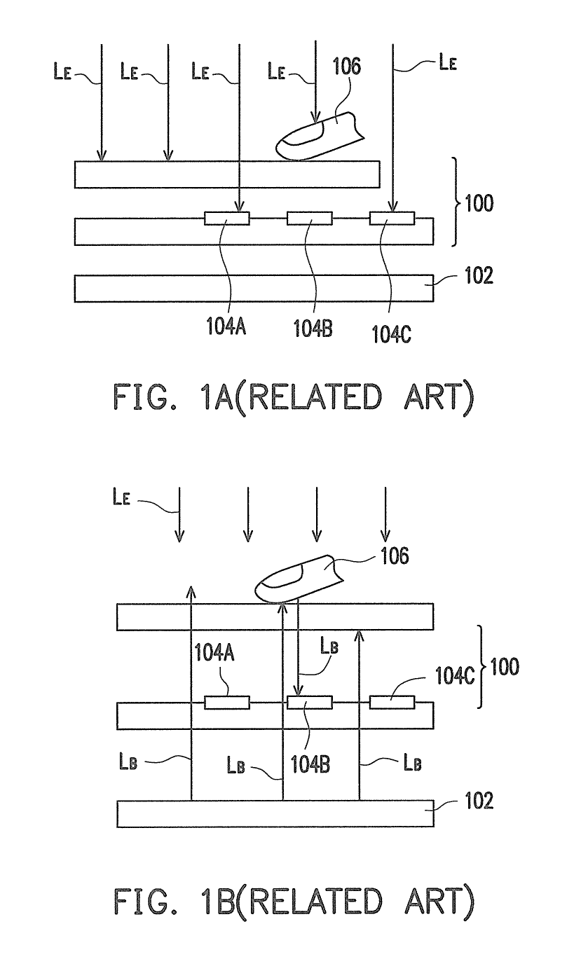

FIG. 2 is a diagram of an optical touch panel according to an embodiment of the present invention.

FIG. 3 is a flowchart of a touched position identification method according to an embodiment of the present invention.

FIG. 4 is an operation timing diagram of a touched position identification method according to an embodiment of the present invention.

FIG. 5A and FIG. 5B are diagrams of image data obtained when five fingers touch an optical touch panel and a controllable light source is respectively turned on and off.

FIG. 6 is an operation timing diagram of a touched position identification method according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

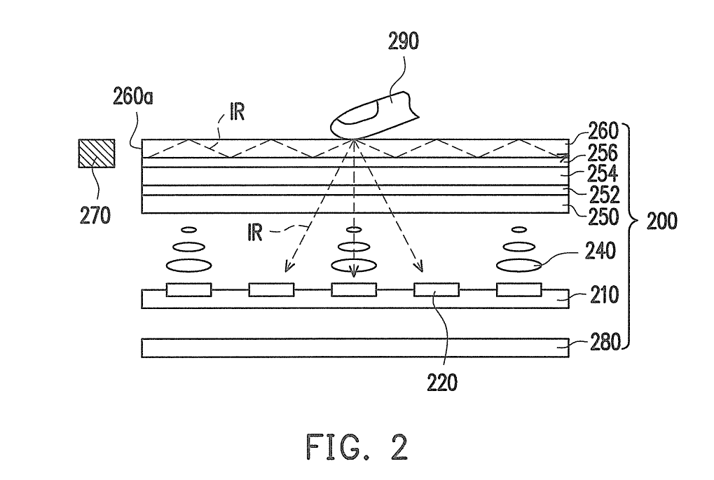

FIG. 2 is a diagram of an optical touch panel according to an embodiment of the present invention. Referring to FIG. 2, the optical touch panel 200 includes a first substrate 210, a second substrate 250, a display medium 240 between the first substrate 210 and the second substrate 250, a light guide plate 260, and a controllable light source 270.

The first substrate 210 may be an active device array substrate disposed with a plurality of pixel structures (not shown) and a plurality of optical sensors 220, wherein each of the optical sensors 220 is disposed corresponding to one of the pixel structures. The second substrate 250 may be a color filter substrate disposed with a black matrix layer (not shown) and a color filter layer (not shown). The display medium 240 may be liquid crystal molecules.

It should be noted that in the present embodiment, the light guide plate 260 is disposed at one side of the second substrate 250, and the controllable light source 270 is disposed at a light incident side 260a of the light guide plate 260. In FIG. 2, the light guide plate 260 is disposed above the second substrate 250. However, the light guide plate 260 may also be disposed below the second substrate 250 (not shown). Besides, in FIG. 2, the light guide plate 260 is additionally disposed on the second substrate 250. However, in other embodiments, the second substrate 250 (a transparent substrate) may also be directly served as a light guide plate, and the controllable light source 270 is disposed at the light incident side (not shown) of the second substrate 250.

The controllable light source 270 may be an infrared light emitting diode (IR-LED) that emits infrared light IR. In the usual state (i.e., the optical touch panel 200 is not touched by an object 290), the infrared light IR emitted by the controllable light source 270 is totally internally reflected in the light guide plate 260. However, when the object 290 touches the optical touch panel 200, the total internal reflection of the infrared light IR within the light guide plate 260 is interrupted by the object 290, so that the infrared light IR emitted by the controllable light source 270 is emitted out of the light guide plate 260 at the position touched by the object 290 and accordingly is detected by the optical sensors 220.

In the present embodiment, the optical touch panel 200 may further include an adhesive layer 252, a polarizer 254, and a total internal reflection coating 256 sequentially disposed on the second substrate 250. Besides, the optical touch panel 200 may further include a backlight module 280 disposed below the first substrate 210 if the optical touch panel 200 is a transmissive display panel or a transflective display panel. Or, the backlight module 280 may also be omitted if the optical touch panel 200 is a reflective display panel.

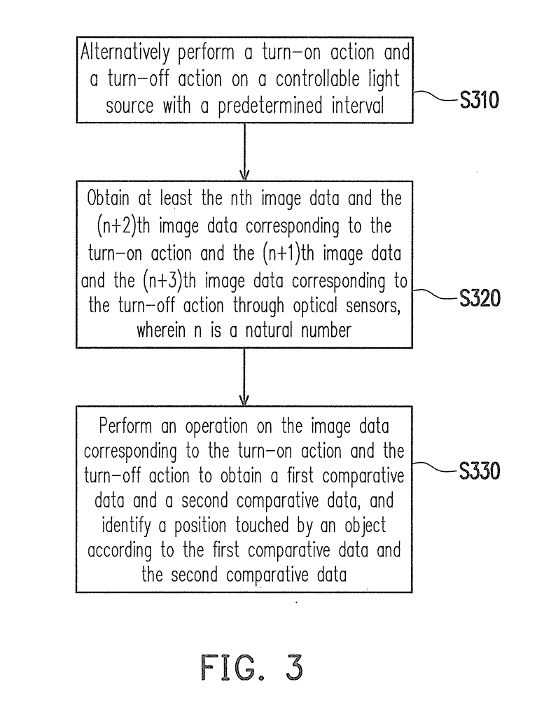

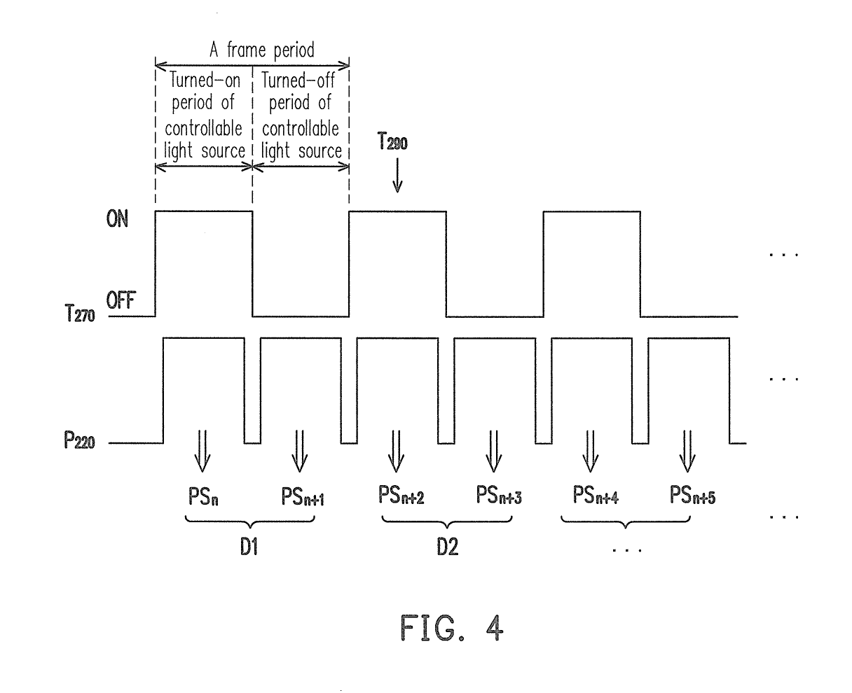

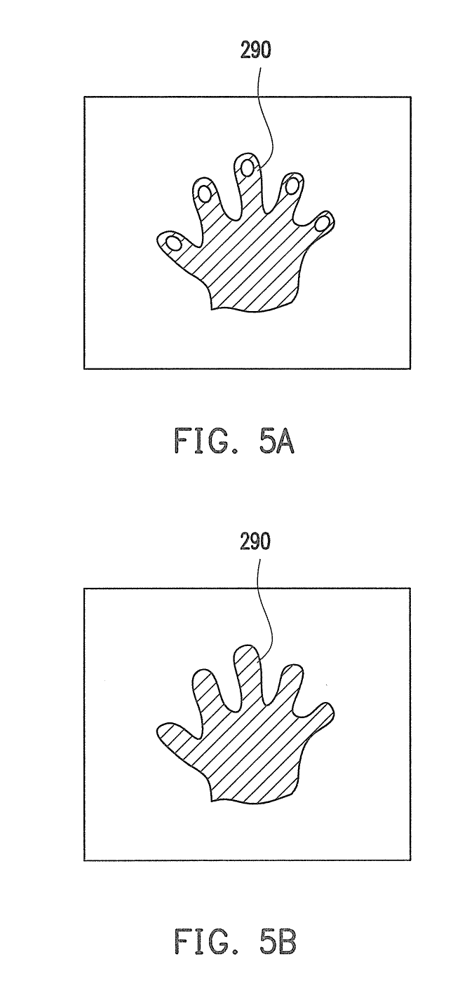

Next, the touched position identification method in an embodiment of the present invention will be described with reference to FIGS. 2-5B. FIG. 3 is a flowchart of a touched position identification method according to an embodiment of the present invention. FIG. 4 is an operation timing diagram of a touched position identification method according to an embodiment of the present invention. FIG. 5A and FIG. 5B are diagrams of image data obtained when five fingers touch an optical touch panel and a controllable light source is respectively turned on and off.

Referring to FIGS. 2-5B, first, in step S310, a turn-on action and a turn-off action are alternatively performed on the controllable light source 270 with a predetermined interval. To be specific, the controllable light source 270 may be connected to a timing controller (not shown) and accordingly have a turned-on period and an alternative turned-off period, wherein the turned-on period and the turned-off period of the controllable light source 270 form a frame period. The timing T₂₇₀ of the turned-on period and the turned-off period of the controllable light source 270 is illustrated in FIG. 4.

Next, in step S320, when the controllable light source 270 is turned on, the n^{th} image data PSₙ, the (n+2)^{th} image data PS₍ₙ₊₂₎, the (n+4)^{th} image data PS₍ₙ₊₄₎, . . . corresponding to the turn-on action is obtained through the optical sensors 220, and when the controllable light source 270 is turned off, the (n+1)^{th} image data PS₍ₙ₊₁₎, the (n+3)^{th} image data PS₍ₙ₊₃₎, the (n+5)^{th} image data PS₍ₙ₊₅₎, . . . corresponding to the turned-off period is obtained through the optical sensors 220. In particular, at least the n^{th} image data and the (n+2)^{th} image data corresponding to the turn-on action and the (n+1)^{th} image data and the (n+3)^{th} image data corresponding to the turn-off action is obtained through the optical sensors 220, wherein n is a natural number. The image data P₂₂₀ obtained through the optical sensors 220 is illustrated in FIG. 4.

Below, how the image data P₂₂₀ is obtained through the optical sensors 220 according to the timing T₂₇₀ of the turned-on period and the turned-off period of the controllable light source 270 will be further described. It should be noted that only part of the image data PSₙ, PS₍ₙ₊₁₎, PS₍ₙ₊₂₎, and PS₍ₙ₊₃₎ is obtained through the optical sensors 220 in FIG. 4. However, more image data can be actually obtained through the optical sensors 220.

FIG. 4 illustrates the time point T₂₉₀ on which the object 290 starts to touch the optical touch panel 200 when the image data PS₍ₙ₊₂₎ is obtained. Actually, the object 290 can touch the optical touch panel 200 at any time point, and the position touched by the object 290 can be determined as long as the two image data (for example, the image data PSₙ and PS₍ₙ₊₁₎) corresponding to the turned-on period and the turned-off period of the controllable light source 220 is obtained when the object 290 touches the optical touch panel 200.

Below, it is assumed that the object 290 does not touch the optical touch panel 200 when the n^{th} image data PSₙ is obtained and when the (n+1)^{th} image data PS₍ₙ₊₁₎ is obtained, and touches the optical touch panel 200 when the (n+2)^{th} image data PS₍ₙ₊₂₎ is obtained and when the (n+3)^{th} image data PS₍ₙ₊₃₎ is obtained.

When the optical touch panel 200 is not in the touch sensing statue (i.e., not touched by the object 290), the light emitted by the controllable light source 270 is conducted within the light guide plate 260 therefore is not detected by the optical sensors 220. Thus, the optical sensors 220 only receive the ambient light and accordingly always obtain the same image data PS₍ₙ₎ and PS₍ₙ₊₁₎ during either the turned-on period or the turned-off period of the controllable light source 270.

When the object 290 touches the optical touch panel 200 and it is during the turned-on period of the controllable light source 270, the object 290 interrupts the total internal reflection of the light within the light guide plate 260 so that the light conducted within the light guide plate 260 is emitted out of the light guide plate 260 and accordingly detected by the optical sensors 220. Accordingly, as shown in FIG. 4, the image data PS₍ₙ₊₂₎ is obtained. In other words, as shown in FIG. 5A, the image data PS₍ₙ₊₂₎ is obtained when the optical sensors 220 detect the light emitted out of the light guide plate 260 and the ambient light partially blocked by the object 290.

In addition, when the object 290 touches the optical touch panel 200 and it is during the turned-off period of the controllable light source 270, the image data detected by the optical sensors 220 may be the image data PS₍ₙ₊₃₎ illustrated in FIG. 4. In other words, as shown in FIG. 5B, the image data PS₍ₙ₊₃₎ is obtained when the optical sensors 220 detect the ambient light partially blocked by the object 290.

Next, an operation is performed on the image data obtained as illustrated in FIG. 5A and FIG. 5B to determine the position touched by the object 290 on the optical touch panel 200. To be specific, referring to FIGS. 2-5B, in step S330, an operation is performed on the image data corresponding to the turn-on action and the turn-off action to obtain a first comparative data D1 and a second comparative data D2, and the position touched by the object 290 is identified according to the first comparative data D1 and the second comparative data D2.

The meaning of obtaining at least the n^{th} image data to the (n+3)^{th} image data mentioned above is that there should be are at least four image data to select one of two operation modes to perform the operation on the image data. Thereby, the selection of the operation mode is made more flexible. In the first operation mode, the operation is performed on every two image data ((n, (n+1)) and ((n+2), (n+3))). As shown in FIG. 4, the operation is performed on the n^{th} image data PSₙ and the (n+1)^{th} image data PS₍ₙ₊₁₎ to obtain the first comparative data D1, the operation is performed on the (n+2)^{th} image data PS₍ₙ₊₂₎ and the (n+3)^{th} image data PS₍ₙ₊₃₎ to obtain the second comparative data D2, and so on.

The operation mentioned herein may be an addition operation, a subtraction operation, an XOR operation, or a difference operation performed on the image data, and such an operation can eliminate the noises caused by the shadow of the object 290 and the ambient light and make the position touched by the object 290 clear, so that the position touched by the object 290 can be correctly identified.

To be specific, in the present embodiment, the an XOR operation is performed on the n^{th} image data PSₙ and the (n+1)^{th} image data PS₍ₙ₊₁₎ to obtain the first comparative data D1. In this operation, as described above, when the optical touch panel 200 is not in the touch sensing state, the n^{th} image data PSₙ corresponding to the turned-on period of the controllable light source 270 and the (n+1)^{th} image data PS₍ₙ₊₁₎ corresponding to the turned-off period of the controllable light source 270 are the same. Namely, there is no difference between the n^{th} image data PSₙ and the (n+1)^{th} image data PS₍ₙ₊₁₎. Thus, it can be determined according to the first comparative data D1 that the optical touch panel 200 is not touched. Namely, a function of identifying whether the object 290 touches the optical touch panel 200 is achieved.

In addition, as described above, when an XOR operation is performed on the (n+2)^{th} image data PS₍ₙ₊₂₎ and the (n+3)^{th} image data PS₍ₙ₊₃₎ illustrated in FIG. 5A and FIG. 5B, the noises caused by the shadow of the object 290 and the ambient light are eliminated and the second comparative data D2 illustrated in FIG. 4 is obtained. In other words, the position touched by the object 290 can be precisely identified according to the second comparative data D2.

Namely, when a difference operation is performed on the (n+2)^{th} image data PS₍ₙ₊₂₎ and the (n+3)^{th} image data PS₍ₙ₊₃₎ in FIG. 5A and FIG. 5B, the noises caused by the shadow of the object 290 and the ambient light are eliminated and the second comparative data D2 illustrated in FIG. 4 is obtained, and the position touched by the object 290 is identified according to the second comparative data D2. As described above, in the touched position identification method, an operation is performed on the image data to eliminate noises caused by the shadow of the object 290 and the ambient light and make the position touched by the object 290 clear enough, so that the position touched by the object 290 can be correctly identified.

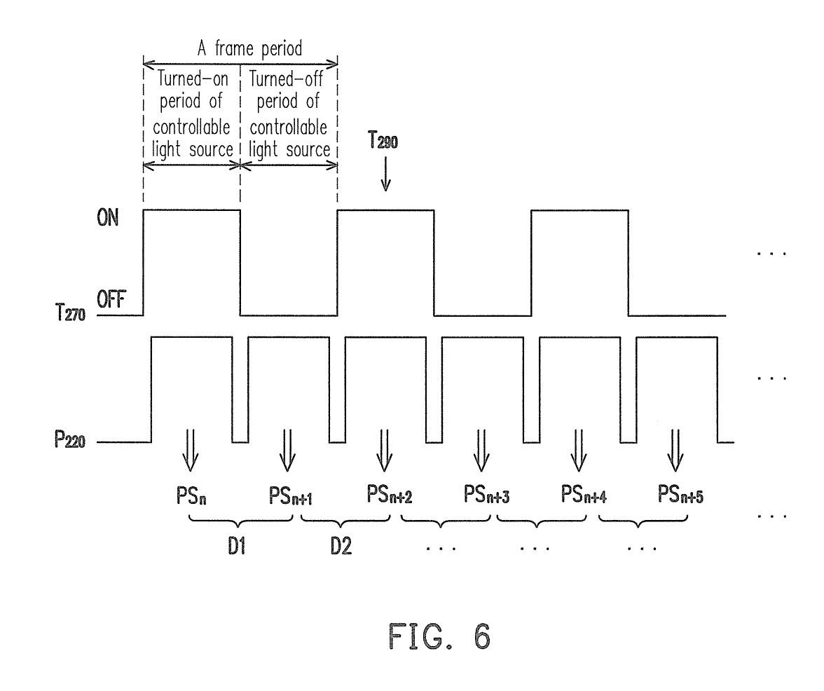

FIG. 6 is an operation timing diagram of a touched position identification method according to another embodiment of the present invention. According to the embodiment illustrated in FIG. 6, in the second operation mode, an operation is performed on adjacent two image data to obtain the comparative data. Namely, the operation is performed on the n^{th} image data PSₙ and the (n+1)^{th} image data PS₍ₙ₊₁₎ to obtain the first comparative data D1, and the operation is performed on the (n+1)^{th} image data PS₍ₙ₊₁₎ and the (n+2)^{th} image data PS₍ₙ₊₂₎ to obtain the second comparative data D2, and so on.

As shown in FIG. 6, it is assumed that the object 290 is always in contact with the optical touch panel 200, at least two image data (for example, the image data PS_{(n)-PS}₍ₙ₊₁₎ is obtained, and the operation is performed on adjacent two image data PS₍ₙ₎−PS₍ₙ₊₁₎ to obtain the comparative data. The position touched by the object 290 is determined according to the comparative data. The efficiency in using the image data is improved in the second operation mode. Compared to the first operation mode illustrated in FIG. 4, the second operation mode illustrated in FIG. 6 offers reduced operation time and improved efficiency of the touched position identification method.

As described above, in a conventional optical touch panel, noises may be produced by the shadow of the object 290 and the ambient light such that the touched position may not be correctly identified. However, in the present embodiment, an image data is respectively obtained during a turned-on period and a turned-off period of the controllable light source 270 through the optical sensors 220, such that noises caused by the shadow of the object 290 and the ambient light can be eliminated and the position touched by the object 290 can be made more obvious. In other words, in the touched position identification method of the present embodiment, image data under different situations is obtained by turning on and off the controllable light source, and noises caused by object shadow and ambient light are eliminated through a simple operation.

As described above, the touched position identification method in the present invention has at least following advantages.

An image data is respectively obtained through optical sensors during a turned-on period and a turned-off period of a controllable light source by turning on and off the controllable light source, and an operation is performed on the image data to precisely identify a position touched by an object. Because the noises produced by ambient light can be eliminated in an optical touch panel having the controllable light source and a light guide plate through foregoing method, the optical touch panel will not lose its touch sensing ability when it is used in a too bright or too dark environment. Thereby, the optical touch panel can be applied in environments with different light intensities.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touched position identification method, for identifying a position touched by an object on an optical touch panel, wherein the optical touch panel comprises a first substrate, a second substrate, a display medium between the first substrate and the second substrate, a light guide plate, and a controllable light source, a plurality of optical sensors is disposed on the first substrate, the light guide plate is disposed at one side of the second substrate, and the controllable light source is disposed at a light incident side of the light guide plate, the touched position identification method comprising:
alternatively performing a turn-on action and a turn-off action on the controllable light source with a predetermined interval;
obtaining at least a n^{th} image data and a (n+2)^{th} image data corresponding to the turn-on action and a (n+1)^{th} image data and a (n+3)^{th} image data corresponding to the turn-off action by using the optical sensors, wherein n is a natural number; and
performing an operation on the n^{th} image data and the (n+2)^{th} image data corresponding to the turn-on action and the (n+1)^{th} data and the (n+3)^{th} image data corresponding to the turn-off action to obtain a first comparative data and a second comparative data, and identifying the position touched by the object according to the first comparative data and the second comparative data.

2. The touched position identification method according to claim 1, wherein) the first comparative data is obtained according to the n^{th} image data and the (n+1)^{th} image data; and
the second comparative data is obtained according to the (n+2)^{th} image data and the (n+3)^{th} image data.

3. The touched position identification method according to claim 1, wherein the first comparative data is obtained according to the n^{th} image data and the (n+1)^{th} image data; and
the second comparative data is obtained according to the (n+1)^{th} image data and the (n+2)^{th} image data.

4. The touched position identification method according to claim 1, wherein the operation comprises an addition operation.

5. The touched position identification method according to claim 1, wherein the operation comprises a subtraction operation.

6. The touched position identification method according to claim 1, wherein the operation comprises an XOR operation.

7. The touched position identification method according to claim 1, wherein the operation comprises a difference operation.
